(19) United States
(12) Patent Application Publication
(10) Pub. No.: US 2010/0063914 A1
(43) Pub. Date: Mar. 11, 2010

(54) Financial management system

(76) Inventors: Erin Lozano, Santa Barbara, CA (US); Masen Yaffee, Santa Barbara, CA (US)

Correspondence Address: MARK RODGERS, 1590 SAN ROQUE ROAD, SANTA BARBARA, CA, 93105, US

(21) Appl. No.: 12/231,886

(22) Filed: Sep. 5, 2008

(51) Int. Cl. G06Q 40/00

(52) U.S. Cl. 705/35

(57) ABSTRACT

A web based financial management system, allowing access to personal financial data through a web browser to server based software. The system supports access of data from the web from financial institutions such as credit cards, lenders, banks, and service providers, such as utilities. An important feature is a cash flow management system that allows for detailed future projections based on both historical, and both recurring and non-recurring future known and estimated transactions. A unique discussion element allows for focused discussed of specific elements of the financial schedule with collaborators.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to management of finances, and in particular personal finance management utilizing a web-based service.

Existing personal financial management solutions focus on financial history. Financial Application software exists, such as Quicken or Mint, which track historical transactions—income and expenses—and print out charts and graphs which are useful to analyze personal financial history. However existing personal solutions provide at most rudimentary tools for future planning and gaining control of personal finances going forward.

Software tools for business do have Cash Flow Projection tools, which provide a view of future financial performance based on historical data, and estimates of future events. Such tools range from relatively simple accounting software such as Quickbooks up to very complex Finance and Inventory management software aimed at multimillion dollar businesses. Such tools tend to provide very flexible forecasting tools, but because of their requirement to handle a large range of financial elements, such as payroll, inventory, as well as income and expenses, these tools must be capable of handling a wide range of inputs. As such they do not have the specific features, presented in an easy-to-use format, desirable in a personal financial management system

A personal user's financial interactions tend to be with banks, credit card companies and financial institution such as utility companies, mortgage lenders and the like. Most of these can be accessed over the Internet, and the trend is for the number of internet-accessible institutions to increase. Moreover, a personal user may want to check into financial information or make transactions at random times, not necessarily just when at home sitting in front of a PC running a software application such as Quicken. Since all of the data is on the net, and the user may want to access the data at a variety of times and places, it makes sense for the financial management system to exist at the server level and allow access from a browser, thus enabling access from any Internet appliance, such as a PC, PDA or smart-phone.

Finally, a personal user may want advice and to collaborate with others such as a spouse, relative or financial advisor. Some existing web-based services have provided data sharing, but it is in the social networking sense, of generalized postings to top level pages. Collaboration from others needs to be focused and controlled to truly be a useful and safe feature.

### BRIEF SUMMARY OF THE INVENTION

The invention is a financial management system for users on the Internet which includes a software program executing on at least one web server, consisting of a plurality of integrated applications. One application is an interface for permission-controlled user access to the server software across the Internet from a user level web browser, such that the interface supports entry, modification, categorization and display of user financial data stored on the server into at least one schedule, as well as control of the server software applications. Other applications include an account manager application that at a minimum:
syncs with user financial institutions for up-to-date transactions and accurate balances
automatically categorizes user data
through the browser interface the user can at a minimum edit user transactions and categories, create split transactions, and reconcile user accounts against user bank statements,

Other server level applications include a cash flow projection application that at a minimum:
creates a forecast of future cash flow based on historical spending and future projected expenses and income,
accepts user entry of at least one of one-time anticipated transactions, or creation of structured schedules including bi-weekly or bi-monthly transactions
   Another application is a discussion manager that allows a user to annotate transactions and invite other users to view their accounts and annotations, and the invited user may reply to the annotations in an ongoing manner.

In a particular embodiment at least one other schedule may be created utilizing at least one of the same categories as the first schedule, and the second schedule may forecast in parallel with the first schedule.

### BRIEF DESCRIPTION OF THE DRAWINGS

The invention will be better understood by referring to the following figures.

FIG. 1 is a depiction of the general operation of a web-based financial management system.

### DETAILED DESCRIPTION OF THE INVENTION

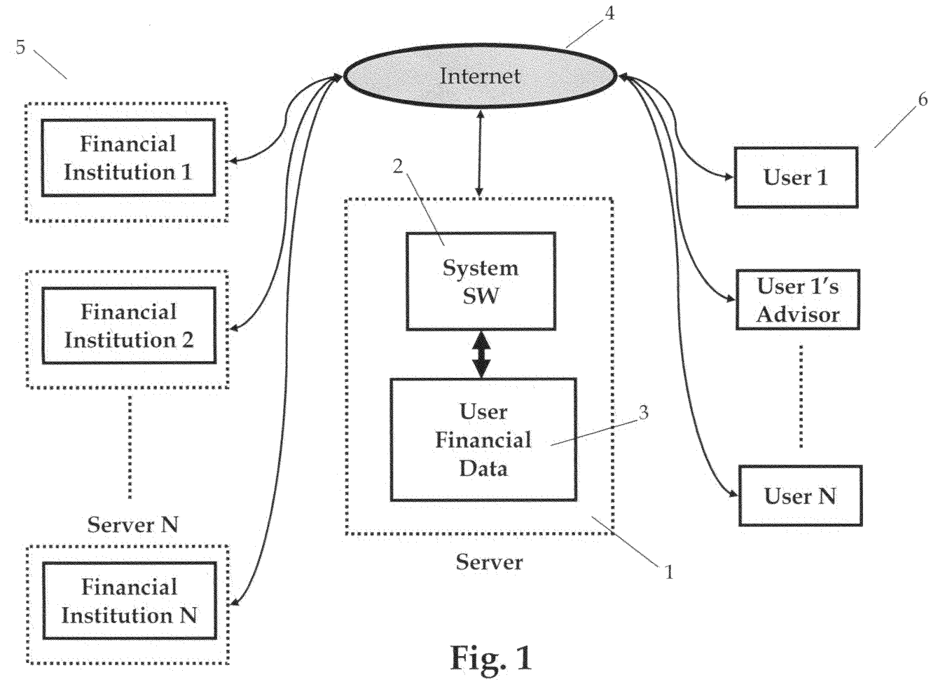

Referring to FIG. 1, a system exists on at least one Internet server. It is preferable that all system operating applications run as software 2 on the server, and that all user data is 3 is stored on the server as well. One application supports user access through a browser only. Thus Users, and their advisors and collaborators, 6 may access the system form any Internet appliance supporting a browser, from anywhere access to the Internet 4 is available. The System also may directly access the user's financial institutions 5, such as banks, lenders, credit cards, utilities and so on.

Although some elements of the novel system exist in various forms, no known system provides the full set of features presented in this application. A detailed description of each element of the system follows, at a level sufficient for a programmer skilled in the art to code the system. A complete feature set is described, but it is understood that not all the features are required for novelty.

### Account Manager

A user may add a new account by syncing with a bank or banks, manually entering an account or importing from a QIF/QFX file. A user can also set-up an account to sync with a bank each night. A user may edit account information, such as name, opening balance, opening date, and reconcile an account against a bank statement. A user can enter and edit transaction information in the check register, generate reports and categorize transactions. Alternatively a user can create a new account by choosing the type of account, name of account and opening balance and opening balance date, and can edit their account name, account type and whether it syncs with the bank each night.

A user can see unreconciled transactions (debits and credits) and reconcile them against a bank statement. A Check Register for any account allows the user to enter dates, type, payee, cleared status, amount, category and memo in the check register. A user can use splits to split out one transaction for one payee into multiple amounts associated with categories.

A user may categorize transactions. The system includes an auto-categorize function, of a type known in the art, to automatically categorize transactions brought into the register when the system syncs with financial institutions.

### Cash Flow Management

A user may generate a cash flow projection from historical data in the system. The user can view the historical data for all categories which are divided into income, fixed expenses and optional expenses. The amount for each category is initially set to a number which is the average of the previous 12 months of expenditures for that category. The user can then modify that number to create a future budgeted amount which becomes the basis for the initial cash flow projection. Additionally, the user can add/edit a schedule for a particular category if desired. The schedule contains the details of a specific future transaction including a label, amount, start date, end date and periodicity. Once all of the initial budgeted numbers are created and any specific schedules are added to flush out the cash flow projection, it will then display an accurate forecast of the user's financial picture by month for a future period, the next 12 months, for example, including a number for the initial balance in the user's selected bank accounts, the amount of cash flow and the final account balance (which is the initial balance minus the cash flow for that month). The cash flow projection is therefore a chart of tabular data which displays a combination of budgeted averages by category plus specific future projected one-time or periodic income or expense transactions.

### Projects

A user may generate multiple different cash flow projections which are known as projects. Each project can be named and the cash flow projection can be displayed showing any individual project's transactions or as an aggregate projection of all projects.

If the user's cash flow is positive for the month, the balance is added to a category called “goals”. This put-aside flows into the GoalKeeper module where the user can allocate funds towards the attainment of future financial goals.

A user can choose the bank accounts that are included in the cash flow projection and define projects and schedules as defined above. Schedules may be for periodic or one-time transactions.

### Discussion/Collaboration

A user can invite someone, such as a relative or financial manager to share their account in order to have online conversations with invited person in the system. The conversation may be related to specific transactions in the account register, cash flow module or goalkeeper. The selected transaction is annotated, and the annotations may be replied to in an ongoing manner

### Goalkeeper

If a user has goal funds allocated, these will display within the goalkeeper module. The goalkeeper module allows a user to add/edit/delete an unlimited number of financial goals. Each goal consists of a goal label, total cost and monthly allocation. Once the user enters these parameters, the goalkeeper module displays the month and year that the goal will be completed. Financial goals are sorted by date with the closest goals at the top.

In summary, the novel system allows a user to track and categorize historical transactions, make a plan for the future in the form of a cash flow projection, set and track financial goals, and have a collaborate online with a trusted source.

It is envisioned that the novel system be subscription based, and that users are allowed controlled access to the system by means of providing identification, such as username and password received when users sign up for the service.

The specific coding implementation of the features disclosed, is not part of the novelty or required for enablement of the invention, but rather the resulting system as a whole and as claimed is a novel and useful financial tool.

We claim:

1. A financial management system for users on the Internet comprising:
a software program executing on at least one web server consisting of a plurality of integrated applications, those applications comprising;
an interface for permission-controlled user access to the server software across the Internet from a user level web browser, wherein the interface supports entry, modification, categorization and display of user financial data stored on the server into at least one first schedule, as well as control of the server software applications,
an account manager application that at a minimum:
syncs with user financial institutions for up-to-date transactions and accurate balances
automatically categorizes user data; wherein,
through the browser interface the user can at a minimum edit user transactions and categories, create split transactions, and reconcile user accounts against user bank statements,
a cash flow projection application that at a minimum:
creates a forecast of future cash flow based historical spending and future projected expenses and income,
accepts user entry of at least one of one-time anticipated transactions, or creation of structured schedules including bi-weekly or bi-monthly transactions; and,
a discussion manager; wherein,
a user may annotate transactions and invite other users to view their accounts and annotations, and the invited user may reply to the annotations in an ongoing manner.

2. The system of claim 1 wherein at lest one second schedule may be created utilizing at least one of the same categories as the first schedule, and the second schedule may forecast in parallel with the first schedule.
